(19) United States
(12) Patent Application Publication
(10) Pub. No.: US 2024/0296372 A1
(43) Pub. Date: Sep. 5, 2024

(54) MODELING USER-GENERATED SEQUENCES IN ONLINE SERVICES

(71) Applicant: Microsoft Technology Licensing, LLC, Redmond, WA (US)

(72) Inventors: Sumit SRIVASTAVA, Bangalore (IN); Shilpi Agrawal, Bangalore (IN); Nithish Divakar, Bangalore (IN); Srinivasa Madhava Phaneendra Angara, Bangalore (IN)

(21) Appl. No.: 18/116,033

(22) Filed: Mar. 1, 2023

(51) Int. Cl. G06N 20/00

(52) U.S. Cl. CPC G06N 20/00

(57) ABSTRACT

In an example embodiment, a scalable hybrid approach for sequence modeling of online network interactions is provided. This hybrid approach combines generative modeling, including determining salient aspects of a distribution and estimating the confidence in this determination, along with discriminative modeling, which allows for scalability to provide a scalable and robust approach to model any user-generated sequence in a social network.

### TECHNICAL FIELD

The present disclosure generally relates to technical problems encountered in machine learning. More specifically, the present disclosure relates to the use of machine learning to model user-generated sequences in online services.

### BACKGROUND

The rise of the Internet has occasioned two disparate yet related phenomena: the increase in the presence of online networks, such as social networking services, with their corresponding user profiles and posts visible to large numbers of people; and the increase in the use of such online networks for various forms of communications.

### BRIEF DESCRIPTION OF THE DRAWINGS

Some embodiments of the technology are illustrated, by way of example and not limitation, in the figures of the accompanying drawings.

FIG. 1 is a block diagram showing the functional components of a social networking service, including a data processing module referred to herein as a search engine, for use in generating and providing search results for a search query, consistent with some embodiments of the present disclosure.

FIG. 2 is a block diagram illustrating the application server module of FIG. 1 in more detail, in accordance with an example embodiment.

FIG. 3 is a block diagram illustrating the machine learning training component in more detail, in accordance with an example embodiment.

FIG. 4 is a block diagram illustrating the machine learning training component in more detail, in accordance with an example embodiment.

FIG. 5 is a flow diagram illustrating a method of training a sequence-prediction machine learning model, in accordance with an example embodiment.

FIG. 6 is a flow diagram illustrating a method of predicting a future sequence based on an input sequence to the sequence-prediction machine learning model, in accordance with an example embodiment.

FIG. 7 is a block diagram illustrating a software architecture, in accordance with an example embodiment.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

The various interactions that occur within an online network and the timing and ordering in which they occur may be called “sequences.” More particularly, a sequence is an ordered list of interactions that occur in an online network, which may be measured either at the user level (e.g., these are the interactions that this particular user had with the online service and when) or at the content level (e.g., these are the interactions various users had with this piece of content on the online network and when).

It may be useful to be able to predict future sequences for various reasons, again either at the content or user level. For example, it can aid in the surfacing of useful and/or professional content and the limiting of non-useful and/or nonprofessional content.

One approach to predicting user-generated sequences of interactions with an online network would be to create a machine learning model to capture the salient aspects of each distribution of interactions. This is technically challenging, however, specifically with respect to accuracy and scalability, as there are many different types of user interactions and many different types of distribution patterns. Accurately capturing the salient aspects of each distribution at the user level can be difficult given the scale and time-variant nature of the distributions.

Generative modeling is a type of machine learning that involves using statistical models to generate new data samples that are similar to the training data. The goal of a generative model is to learn the underlying distribution of the training data and then use this knowledge to synthesize new samples that are representative of the same distribution.

Discriminative modeling is a type of machine learning that focuses on modeling the decision boundary between classes. The goal of a discriminative model is to predict the class label of a given input, based on the features of the input and the relationship between the features and the class labels.

Discriminative models are typically used for classification tasks, where the goal is to assign a class label to a given input based on the input's features. Examples of discriminative models include logistic regression, support vector machines (SVMs), and feedforward neural networks.

In an example embodiment, a scalable hybrid approach for sequence modeling of online network interactions is provided. This hybrid approach combines generative modeling, including determining salient aspects of a distribution and estimating the confidence in this determination, along with discriminative modeling, which allows for scalability to provide a scalable and robust approach to model any user-generated sequence in a social network.

More particularly, during a training phase, a joint distribution of user-generated sequences is modeled along with covariates. A joint distribution is a probability distribution that describes the relationship between multiple random variables. In other words, it is a function that assigns a probability to multiple possible combinations of values of the random variables. A covariate is a feature variable that can have an impact on a prediction, such as an input feature variable that can impact the spread of content across the network (virality). These covariates can be related to, for example, content itself, author of the content, users engaging with the content, and a raw sequence of network signals. The idea behind joint distribution is to allow the system to understand the areas of interest where the joint distribution exhibits different data patterns. The areas of higher density (where more areas of interest lie) encode important information about how the sequences are changing in the online network.

Once the salient areas of joint distribution are identified, the covariates can be segregated into discriminative and non-discriminative groups, based on how impactful the joint distribution finds each covariate to be. A highly discriminative joint distribution can then be computed by marginalizing across non-discriminate covariates in the region of interest. For example, if the system finds that views on a piece of content in a certain time period are most impacted by features about the content creators, the remaining covariates can be marginalized and a joint distribution of only view sequences, times, and creator information can be created.

The space can then also be partitioned based on how the sequences vary against different classes of the discriminative covariates. For example, there may be different partitions of view sequences for weakly connected members (i.e., users who do not have a lot of social connections in the online network), moderately connected members (i.e., users who have a moderate amount of social connections in the online network), and strongly connected members (i.e., users who have a lot of social connections in the online network).

Conditional modeling can then be performed, which computes efficient features on the discriminative joint distribution. Sampling the immediate neighborhood in the distribution allows for quantifying local behavior of the sample. All of these are powerful feature descriptors for discriminatory modeling of user-generated sequences. Conditional modeling can also derive confidence intervals of the sample by computing its deviations from expected behavior represented by the joint distribution. The prediction from the conditional model can be used as a feature, and the confidence in these features can be used as weight terms in a loss function. For example, in rows of the training data where the features have been predicted with low confidence, the loss function can give lower importance to these rows whereas the inverse will be true for rows where features have been predicted with high importance.

One or more discriminative models may then be applied to the training data, given the features from the generative model. The result is that the hybrid solution is able to accurately model different data distributions (such as different user engagements) in a manner that accurately captures the salient aspects of each distribution at a user level, while still being able to scale to large training data sets.

### Description

The disclosed embodiments provide a method, apparatus, and system for training and using a hybrid approach to machine learning for predicting sequences of interactions with an online network. This approach is robust in the face of noisy data, scalable, and able to handle multiple distributions in sequences determined by many covariate factors. It also is extensible to accommodate new distributions that can occur due to changes in user behavior.

The term “sequence” in this context means an ordered list of interactions with an online network. While it is not mandatory, these sequences can also indicate the collecting of the interactions, beyond merely the ordering. More particularly, for example, a sequence may indicate that interaction A occurred, then interaction B occurred, and then interaction C occurred, and so on, and may optionally indicate that interaction A occurred at a first date/time (timestamp), interaction B occurred at a second date/time, and interaction C occurred at a third date/time.

The term “covariates” in this context means any input feature variable that can have an impact on some desired prediction goal, such as the spread of content across an online service (virality). It can be related to post content, author of the post, network users engaging with the content, the raw sequence of network signals, and so forth. Content features may include features like topicality (what topic the post pertains to, such as sports, politics, news, etc.) and sentiment (whether user feedback on the post is positive or negative, or alternatively polite or offensive). Author features include number of connections, followers, activity in the network, past engagement count, and so forth, that can inform the reach the author has in the online network and the popularity of their posts. Engagement features may include user features of users engaging with the content, because the spread of content is often dependent on the cohort interacting with the post. Sequence data of engagement may include the sequence of likes, shares, comments, and the like, which can give direct insight on how the content has been interacted with up to the current time.

The interactions tracked in a sequence can include any interaction made by a user with the online network. The types of interactions are therefore very online-network specific. For example, a social networking service may provide users with the ability to post content, and then also provide other users with the ability to interact specifically with that content in a number of different ways (e.g., view, share, like, subscribe, comment, etc.). One or more or even all of these interaction types may be tracked in a sequence, depending upon the goal of the modeling.

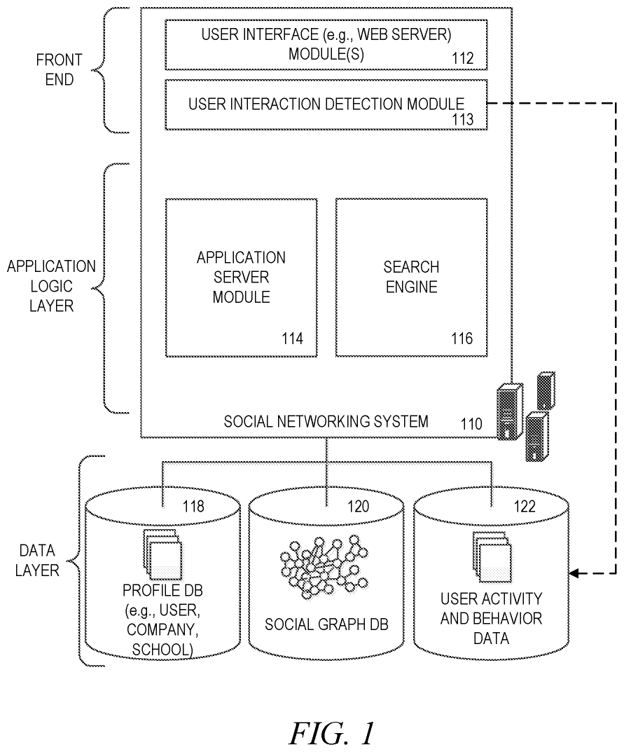

FIG. 1 is a block diagram showing the functional components of a social networking service, including a data processing module referred to herein as a search engine, for use in generating and providing search results for a search query, consistent with some embodiments of the present disclosure.

As shown in FIG. 1, a front end may comprise a user interface module 112, which receives requests from various client computing devices and communicates appropriate responses to the requesting client devices. For example, the user interface module(s) 112 may receive requests in the form of Hypertext Transfer Protocol (HTTP) requests or other web-based Application Program Interface (API) requests. In addition, a user interaction detection module 113 may be provided to detect various interactions that users have with different applications, services, and content presented. As shown in FIG. 1, upon detecting a particular interaction, the user interaction detection module 113 logs the interaction, including the type of interaction and any metadata relating to the interaction, in a user activity and behavior database 122.

An application logic layer may include one or more various application server modules 114, which, in conjunction with the user interface module(s) 112, generate various user interfaces (e.g., web pages) with data retrieved from various data sources in a data layer. In some embodiments, individual application server modules 114 are used to implement the functionality associated with various applications and/or services provided by the social networking service.

As shown in FIG. 1, the data layer may include several databases, such as a profile database 118 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 118. Similarly, when a representative of an organization initially registers the organization with the social networking service, the representative may be prompted to provide certain information about the organization. This information may be stored, for example, in the profile database 118 or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 120.

As users interact with the various applications, services, and content made available via the social networking service, the users' interactions and behavior (e.g., content viewed, links or buttons selected, messages responded to, etc.) may be tracked, and information concerning the users' activities and behavior may be logged or stored, for example, as indicated in FIG. 1, by the user activity and behavior database 122. This logged activity information may then be used by a search engine 116 to determine search results for a search query.

Although not shown, in some embodiments, a social networking system 110 provides an API module via which applications and services can access various data and services provided or maintained by the social networking service. For example, using an API, an application may be able to request and/or receive one or more recommendations. Such applications may be browser-based applications or may be operating system-specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 116 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 116 facilitates the indexing and searching for content within the social networking service, such as the indexing and searching for data or information contained in the data layer, such as profile data (stored, e.g., in the profile database 118), social graph data (stored, e.g., in the social graph database 120), and user activity and behavior data (stored, e.g., in the user activity and behavior database 122). The search engine 116 may collect, parse, and/or store data in an index or other similar structure to facilitate the identification and retrieval of information in response to received queries for information. This may include, but is not limited to, forward search indexes, inverted indexes, N-gram indexes, and so on.

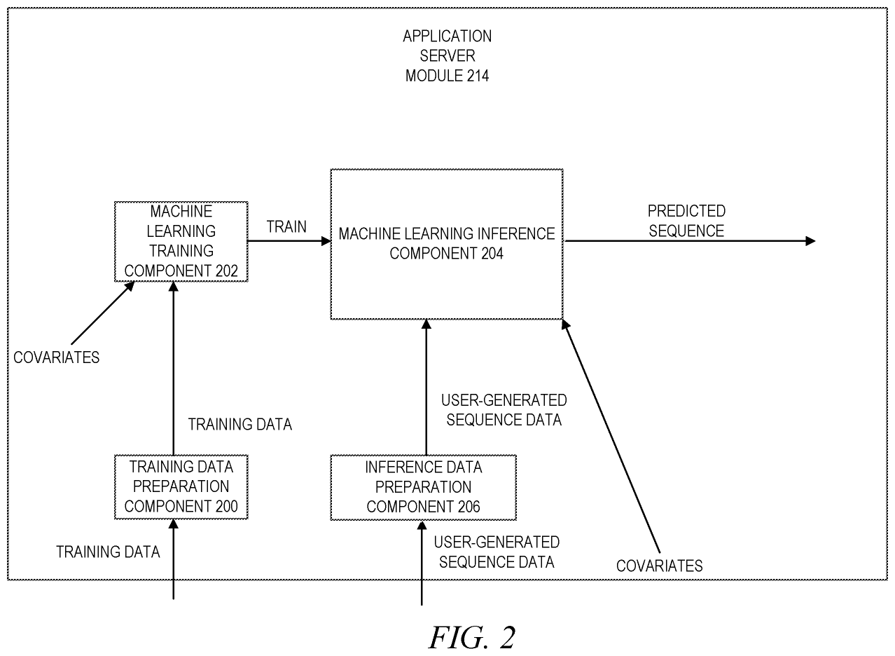

FIG. 2 is a block diagram illustrating application server module 114 of FIG. 1 in more detail, in accordance with an example embodiment. While in many embodiments the application server module 114 will contain many subcomponents used to perform various different actions within the social networking system 110, in FIG. 1, only those components that are relevant to the present disclosure are depicted.

Here, application server module 114 includes a training data preparation component 200, which obtains training data, in the form of either historical sequences (and corresponding information), or sequences that have been artificially generated for training purposes (and corresponding information). This training data is then prepared by the training data preparation component 200. This preparing may include, for example, transforming the training data into a format to be accepted by a machine learning training component 202, such as by filtering, reordering, embedding, and/or otherwise reformatting or altering the training data.

The machine learning training component 202 then takes as input this training data, as well as a plurality of covariates, and uses this information to train a machine learning interference component 204. As mentioned earlier, a covariate is a feature variable that can have an impact on a prediction, such as an input feature variable that can impact the spread of content across the network (virality). At inference time, the machine learning inference component 204 is then able to use user-generated sequence data provided by an inference data preparation component 206, as well as corresponding covariates, and predict a sequence. Specifically, it is able to predict the future portions of a sequence from the past portions of a sequence. For example, it is able to predict that given a sequence where user A and user B shared a post at times 1 and 2, respectively, then an additional 100 users will interact with the post within some future time period (e.g., within the next hour).

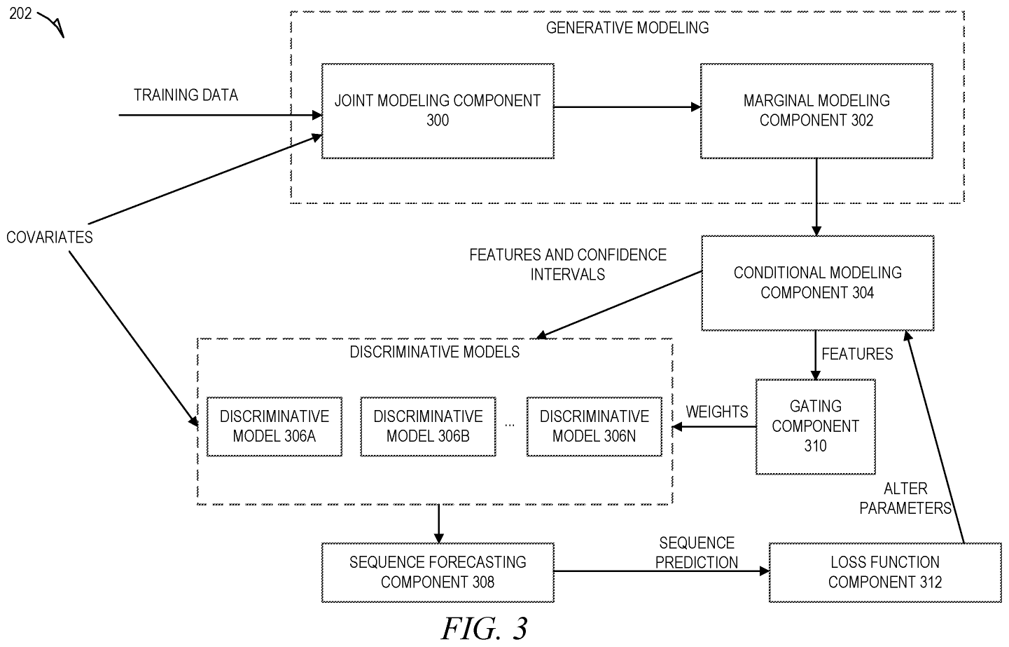

FIG. 3 is a block diagram illustrating the machine learning training component 202 in more detail, in accordance with an example embodiment. The training data and covariates are fed into a joint modeling component 300. The joint modeling component 300 performs joint modeling on both the training data and covariates.

Joint modeling, otherwise known as joint probability modeling, involves using machine learning techniques to model the joint distribution of user generated sequences along with covariates. The main goal here is for the system to understand the areas of interest where the joint distribution exhibits distinct modes or regions. These areas of higher density encode important information about how the sequences are changing in the online network. Examples of joint modeling techniques that may be utilized here include Gaussian Mixture Modeling (GMM) and Kernel Density Estimators (KDE).

Gaussian mixture models are probabilistic models for representing normally distributed subpopulations within an overall population. Mixture models in general lack information about which subpopulation a data point belongs to, allowing the model to learn the subpopulations automatically. Since subpopulation assignment is not known, this constitutes a form of unsupervised learning.

Clustering based on Gaussian mixture model is probabilistic in nature and aims at maximizing the likelihood of the data given k Gaussian components. Considering n data points x={x₁, x₂, . . . xₙ} in d-dimensional space, the density of any given data point x can be defined as follows:

$$p ( x \vert x , ⊖ ) = {{\sum }_{z = 1}}^{k} p ( z \vert π ) \cdot p ( x \vert {θ}_{z} )$$

where π is the prior over the k components and ⊖={θ_{z}:1≤z≤k} are the model parameters of the k Gaussian distributions, i.e.,

$$θ = \{ {μ}_{z} , {\sum }_{z} \} ,$$

and P(x|θ_{z}) is defined as:

$$p ( x \vert {θ}_{z} ) = \frac{1}{{( {( 2 π )}^{d} \vert {\sum }_{z} \vert )}^{\frac{1}{2}}} exp \{ - \frac{1}{2} {( x - {μ}_{z} )}^{T} {\sum }_{z}^{- 1} ( x - {μ}_{z} ) \}$$

Under the assumption that the data points are independent and identically distributed, one can consider the likelihood of the observed samples as follows:

$$\begin{matrix}p ( x \vert π , Θ ) & = {\prod }_{i = 1}^{n} P ( {x}_{i} \vert π , Θ ) \\ & = {\prod }_{i = 1}^{n} {\sum }_{z = 1}^{k} p ( z \vert π ) \cdot p ( {x}_{i} {θ}_{z} )\end{matrix}$$

In order to maximize this likelihood, in one example embodiment, Expectation Maximization (EM) is used as a ranking algorithm. EM is an iterative algorithm in which each iteration contains an E-step and a M-step. In the E-step, the technique computes the probability of the k Gaussian components given the data points, p(z|xᵢ,⊖), using Bayes theorem

$$p ( z \vert {x}_{i} , π , Θ ) = \frac{p ( {x}_{i} \vert {θ}_{z} ) \cdot p ( z \vert π )}{{\sum }_{z = 1}^{k} p ( {x}_{i} \vert {θ}_{z} ) \cdot p ( z \vert π )}$$

In the M-step, this embodiment of the technique computes the model parameters in order to maximize the likelihood of the data, as follows:

$${μ}_{z} = \frac{{\sum }_{i = 1}^{n} {x}_{i} \cdot p ( z \vert {x}_{i} , π , Θ )}{{\sum }_{i = 1}^{n} p ( z \vert {x}_{i} , π , Θ )}$$

$${\sum }_{z} = \frac{{\sum }_{i = 1}^{n} ( {x}_{i} - {μ}_{z} ) \cdot {( {x}_{i} - {μ}_{z} )}^{T} \cdot p ( z \vert {x}_{i} , π , Θ )}{{\sum }_{i = 1}^{n} p ( z \vert {x}_{i} , π , Θ )}$$

$$p ( z \vert π ) = \frac{{\sum }_{i = 1}^{n} p ( z \vert {x}_{i} , π , Θ )}{{\sum }_{z = 1}^{k} {\sum }_{i = 1}^{n} p ( z \vert {x}_{i} , π , Θ )}$$

The EM algorithm is run iteratively until the likelihood reaches the maximum possible value. In one embodiment, the GMM model requires initial estimates of the model parameters θ and prior probability of the components p(z|π). In another example embodiment, K-means is used to derive these initial estimates of model parameters. In general, GMM performs better than classical hard clustering algorithms such as K-means as it is less sensitive to outliers. A drawback of GMM is that it is sensitive to initial estimates of model parameters. This problem can be eliminated by running GMM with boosting. Since this can be computationally expensive, in one embodiment, the technique can run five instances of GMM (with a maximum of 50 iterations each) and picks the one with largest log likelihood as the best estimate of the underlying clusters.

The above clustering algorithm gives probabilistic assignments of data points belonging to a given cluster p(z|x, π, ⊖). For each cluster, in one embodiment, the technique picks all the points with this probability to be greater than 0.9. This is done because the true representative points per cluster is desired. Using these points, the technique computes the average topical signal, resending impact and mention impact (TS, RI, MI) per cluster, and picks the cluster with the larger TS, RI, MI (or best of 3) as the target cluster.

KDEs utilize kernel smoothing for probability density estimation, i.e., a non-parametric method to estimate the probability density function of a random variable based on kernels as weights. KDE answers a fundamental data smoothing problem where inferences about the population are made, based on a finite data sample.

Let (x₁, x₂, . . . , xₙ) be independent and identically distributed samples drawn from some univariate distribution with an unknown density f at any given point x. We are interested in estimating the shape of this function f. Its kernel density estimator is

$${\hat{f}}_{h} ( x ) = \frac{1}{n} {\sum }_{i = 1}^{s} {K}_{h} ( x - {x}_{i} ) = \frac{1}{nh} {\sum }_{i = 1}^{s} K ( \frac{x - {x}_{i}}{h} ) ,$$

where K is the kernel—a non-negative function—and h>0 is a smoothing parameter called the bandwidth. A kernel with subscript h is called the scaled kernel and defined as Kₕ(x)=1/h K(x/h). Intuitively, one wants to choose h as small as the data will allow; however, there is always a trade-off between the bias of the estimator and its variance.

Any of a number of kernel functions may be used: uniform, triangular, biweight, triweight, Epanechnikov, normal, and others.

Referring back to FIG. 3, a marginal modeling component 302 performs marginal modeling (also known as marginal probability modeling) to segregate the covariates into discriminative and non-discriminative groups, based on the salient areas identified by the joint probability modeling. A discriminative covariate is a variable or feature that provides useful information for discriminating or separating different classes or groups in a dataset. In other words, a discriminative covariate is a variable that is able to effectively distinguish between different classes or groups, and is therefore useful for building classifiers or models that can accurately predict the class or group membership of new data points.

There are many techniques that can be used to identify discriminative covariates, including feature selection, feature extraction, dimensionality reduction, and others. The choice of technique depends on the specific requirements and characteristics of the data and the problem being solved.

Discriminative covariates can be grouped to a discriminative group, while the other covariates (known as non-discriminative covariates) can be grouped in a non-discriminative group.

A highly discriminative joint distribution can then be computed by marginalizing against non-discriminate covariates in the region of interest. For example, if the system finds that views on content in a certain time period are most impacted by content creators, then the covariates related to content creators (e.g., creator identification and characteristics) can be used primarily, while the remaining covariates (e.g., user identification and characteristics and/or the identification and characteristics of the content itself) can be marginalized, and a joint distribution of only view sequences, time, and creator can be created.

Furthermore, from this discriminative joint distribution, the space may be partitioned on how sequences vary against different classes of the discriminative covariates. For example, these classes may distinguish among levels of network connectedness for content creators, such that there may be one partition for data regarding content from weakly connected content creators, another partition for data regarding content from moderately connected content creators, and another partition for data regarding content from strongly connected content creators.

The combination of joint probability modeling and marginal probability modeling may be collectively termed “generative modeling.” As will be seen, this generative modeling is used only during the training phase and is not used during an inference phase, at least not for the inference phase for sequence-prediction (the generative models may themselves be machine learning models and thus may have been trained using one or more machine learning algorithms and used in their own inference phases during the training phase for sequence-prediction).

A conditional modeling component 304 then computes efficient features by computing a conditional distribution on the discriminative joint distribution computed during generative modeling. Sampling the immediate neighborhood of the sample in the distribution will allow for quantifying local behavior of the sample. These samples are then powerful feature descriptors or discriminator modeling of user generated sequences, which will be applied later.

Conditional modeling can also derive confidence intervals of the sample by computing its deviations from expected behavior represented by the joint distribution. The prediction from the conditional distribution process can then be used as a feature and the confidence in the features can be used as a weight term, as will be described later.

Conditional modeling may be performed using a classifier model, such XGBoost.

Discriminative models 306A-306N may then be used to perform the actual sequence modeling using the features and confidence intervals provided by the conditional modeling component 304. Each discriminative model 306A-306N may be designed to predict a sequence for a particular partition/region of sequences. For example, one discriminative model 306A may be applied to predict exponential virality growth of a piece of content, while another discriminative model 306B may be applied to predict linear growth of a piece of content. Other types of division, such as having different models for different categories of posts/users, can be used as well.

The discriminative models 306A-306N may perform modeling using a number of different modeling techniques. In one example embodiment, a wide and deep model is utilized, such as a deep and wide neural network. In such a deep and wide model, the edge weights of the neural network and the weights/coefficients of the wide part are learned together. For example, a single training instance may cause the weights of the wide part and the weights of the deep part to be modified in the same iteration.

The discriminative models 306A-306N may also use one or more Autoregressive Integrated Moving Average (ARIMA) models.

The AR part of ARIMA indicates that the evolving variable of interest is regressed on its own lagged (i.e., prior) values. The MA part indicates that the regression error is actually a linear combination of error terms whose values occurred contemporaneously and at various times in the past. The I (for “integrated”) indicates that the data values have been replaced with the difference between their values and the previous values (and this differencing process may have been performed more than once). The purpose of each of these features is to make the model fit the data as well as possible.

Given time series data Xₜ where t is an integer index and the Xₜ are real numbers, an ARIMA(p′,q) model is given by Xₜ−α₁Xₜ₋₁− . . . −α_{p′}X_{t-p′}=εₜ+θ₁εₜ₋₁+ . . . +θ_{q}ε_{t-q}, or equivalently by

$$( 1 - {\sum }_{i = 1}^{{p}^{′}} {α}_{i} {L}^{i} ) {X}_{t} = ( 1 + {\sum }_{i = 1}^{q} {θ}_{i} {L}^{i} ) {ε}_{t}$$

where L is the lag operator, the α₁ are the parameters of the autoregressive part of the model, the θᵢ are the parameters of the moving average part, and the εₜ are error terms. The error terms εₜ are generally assumed to be independent, identically distributed variables sampled from a normal distribution with zero mean.

Assume now that the polynomial

$$( 1 - {\sum }_{i = 1}^{{p}^{′}} {α}_{i} {L}^{i} )$$

has a unit root (a factor (1−L)) of multiplicity d. Then it can be rewritten as:

$$( 1 - {\sum }_{i = 1}^{{p}^{′}} {α}_{i} {L}^{i} ) = ( 1 - {\sum }_{i = 1}^{{p}^{′} - d} {φ}_{i} {L}^{i} ) {( 1 - L )}^{d} .$$

An ARIMA(p, d, q) process expresses this polynomial factorization property with p=p′−d, and is given by:

$$( 1 - {\sum }_{i = 1}^{p} {φ}_{i} {L}^{i} ) {( 1 - L )}^{d} {X}_{t} = ( 1 + {\sum }_{i = 1}^{q} {θ}_{i} {L}^{i} ) {ε}_{t}$$

and thus can be thought as a particular case of an ARMA(p+d, q) process having the autoregressive polynomial with d unit roots. (For this reason, no process that is accurately described by an ARIMA model with d>0 is wide-sense stationary.)

The above can be generalized as follows.

$$( 1 - {\sum }_{i = 1}^{p} {φ}_{i} {L}^{i} ) {( 1 - L )}^{d} {X}_{t} = δ + ( 1 + {\sum }_{i = 1}^{q} {θ}_{i} {L}^{i} ) {ε}_{t} .$$

This defines an ARIMA(p, d, q) process with

$$drift \frac{δ}{1 - \sum {φ}_{i}} .$$

The outputs of the discriminative models 306A-306N are various predictions of future sequences. A sequence forecasting component 308 then needs to aggregate these prediction(s) into a single prediction. It may utilize weights that were generated by a gating component 310 to weight the various predictions.

More particularly, the weights indicate how much importance the sequence forecasting component 308 should apply to each discriminative model 306A-306N. The weights can be generated in a number of different ways, as will be described in more detail below. The reason that the gating component 310 is shown providing these weights to the discriminative models 306A-306N is because in situations where the weight for a given discriminative model 306A-306N is zero, there is no need to actually run that model on the input sequence. The resulting predicted sequences from any non-zero weighted discriminative models 306A-306N may be aggregated/combined by the sequence forecasting component 308. This may include, for example, applying a weighted sum to the predictions output by the non-zero weighted discriminative models 306A-306N.

The gating component 310 uses the conditional distribution from the conditional modeling component 304 to identify the regions corresponding to classes of discriminative covariates, and then generates weights for each discriminative model 306A-306N corresponding to the different classes based on that identification. This information is a powerful descriptor because it helps provide an automatic way of region selection in the distribution space. In some example embodiments, a hard gating approach is used, where only one region is selected. In other example embodiments, a soft gating approach is used where multiple regions are selected with the final convergence in output being achieved by using the confidence values as weights. In other words, the confidence values that the gating component 310 calculated during its identification of the regions corresponding to the classes of discriminative covariates are themselves used as the weights for the corresponding discriminative models 306A-306N. Furthermore, in some example embodiment, the weights can also be used as features to the discriminative models 306A-306N themselves.

During the training phase, an additional loss function component 312 may be used to retrain the conditional modeling component 304 based on the sequence-prediction from the sequence forecasting component 308. The loss function component 312 may determine how closely the sequence-prediction matches an expected sequence and use this difference as input to a loss function. The loss function defines how much variation from the expected sequence is allowed. If the loss function indicates that this variation is too much, it may alter parameters of the conditional modeling component 304 and run the training from that portion again.

The result is that the conditional modeling component 304 has been trained so that at runtime it can generate features and confidence intervals to appropriate discriminative models 306A-306N based on inference-time sequence data, with those discriminative models 306A-306N outputting predictions that can be used by the sequence forecasting component 308 to predict a future sequence for the inference-time sequence data.

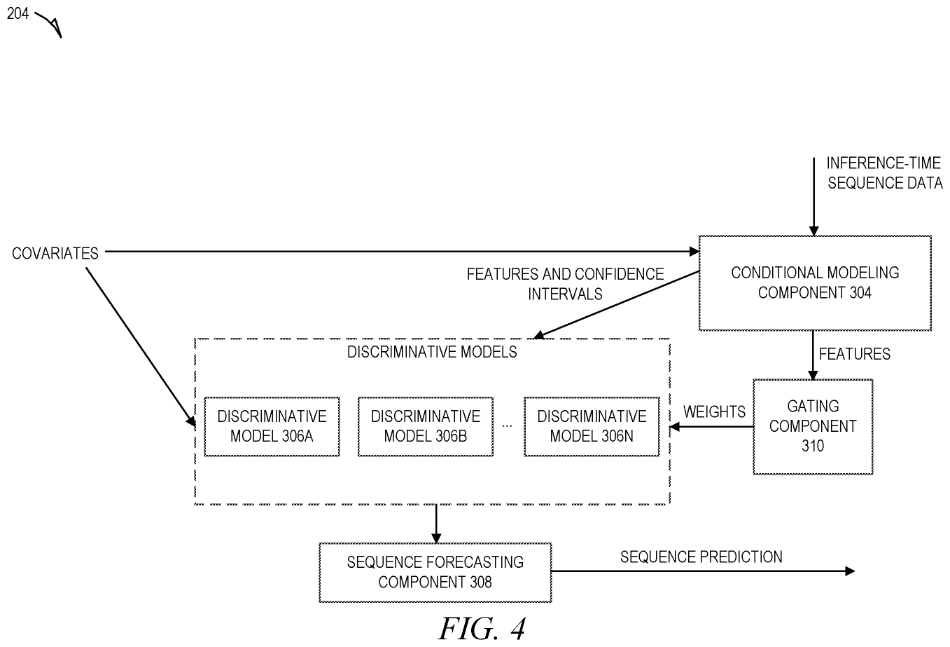

FIG. 4 is a block diagram illustrating the machine learning inference component 204 in more detail, in accordance with an example embodiment. The machine learning inference component 204 is used at inference time, not training time, and as such, as described earlier, the generative modeling aspects are not needed. As such, inference-time sequence data and covariates are passed directly to a conditional modeling component 304. This conditional modeling component 304 performs similarly to the conditional modeling component 304 of FIG. 3, except it has now been trained and is applying its methods to inference-time sequential data instead of training data. Likewise, a gating component 310 performs similarly to the gating component 310 of FIG. 3, and as do the discriminative models 306A-306B and sequence forecasting component 308. Since this is inference time and not training time, the sequence-prediction from the sequence forecasting component 308 is the outputted prediction, and no loss function need be applied.

The outputted prediction may be used in a variety of ways. In one example embodiment, the outputted prediction may be used to determine whether to take one or more actions on a posted piece of content to enhance or reduce its chances for virality. For example, if a sequence-prediction for a particular post shows that the post is likely to go viral, the online network may choose to rank the post in other users' feeds higher, expand the reach of the post to users outside of the posting user's network, and/or otherwise act to promote the post. Likewise, if the sequence-prediction shows that the post is unpopular, the online network may choose to rank the post in other users' feeds lower.

Other examples of actions taken by an online network to enhance or reduce a post's chances for virality include determining if the sequence indicates whether the post is inappropriate or receiving a large number of negative reactions. In such a case, the online network may elect to restrict the virality of the post, such as by blocking sharing of the post.

The outputted prediction may also be used to increase the efficiency of content moderation. One common issue in social networking services is that certain posts contain subject matter that violates terms and conditions laid out by the social networking service, but that may not be picked up by screening mechanisms already in place by the social networking service. Such terms and conditions may, for example, involve forbidding hate speech, violent rhetoric, and/or medical disinformation. Typically when posts that possibly contain such material are flagged, they are placed in a queue for human moderation review. The result, however, is that these queues may be quite large and it can take a lot of time for a human moderator to fully review the posts in the queue. The outputted prediction may be used to triage certain posts for a quicker/higher level of review. For example, a post that is going exponentially viral in a very short period may be placed in a high priority queue so that a human reviewer will review the post sooner than other, lower priority posts.

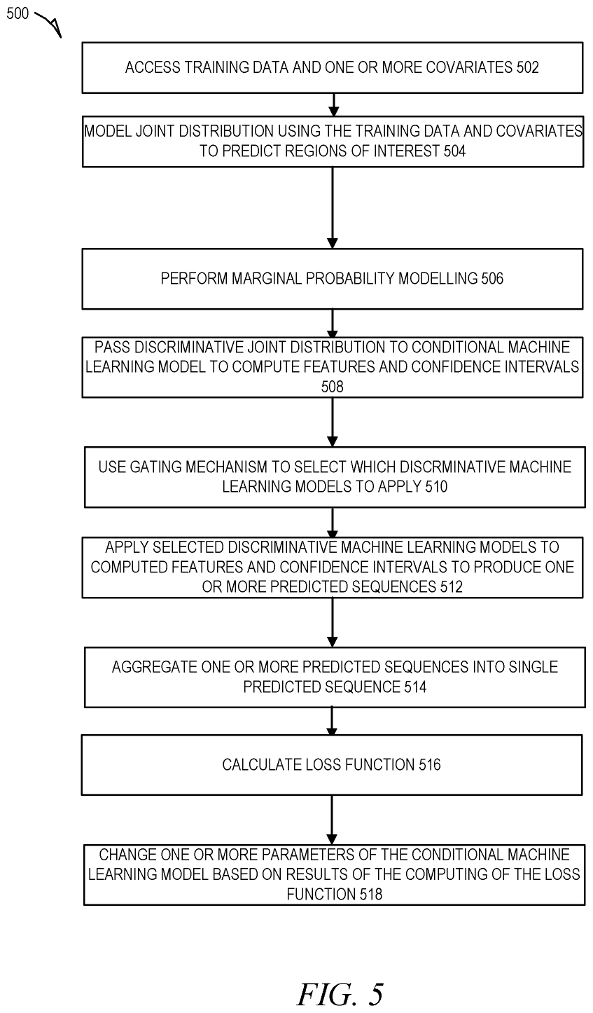

FIG. 5 is a flow diagram illustrating a method 500 of training a sequence-prediction machine learning model, in accordance with an example embodiment. At operation 502, training data and one or more covariates are accessed. The training data comprises sequences of user interactions with an online network. Included in each of these sequences may be, for each interaction, a particular piece of content interacted with, a user who performed the interaction, and a time of the interaction. The covariates may comprise variables related to the sequences.

At operation 504, a joint distribution is modelled using the training data and the covariates to predict regions of interest in the training data. At operation 506, marginal probability modeling is performed to segregate the covariates into discriminative covariates and non-discriminative covariates and to partition the sequences to form a discriminative joint distribution.

At operation 508, the discriminative joint distribution is passed to a conditional machine learning model to compute features from the discriminative joint distribution and derive confidence intervals of the training data by computing deviations in the training data from the discriminative joint distribution. At operation 510, a gating component is used to select which of a plurality of discriminative machine learning models to apply. This may be performed by a hard gating component that selects a single discriminative machine learning model to apply to the computed features and confidence intervals, or by a soft gating component that selects a plurality of discriminative machine learning models to apply to the computing features and confidence intervals and applies weights to each of the plurality of discriminative machine learning models.

At operation 512, the selected one or more discriminative machine learning models are applied to the computed features and confidence intervals to produce one or more predicted sequences. At operation 514, the one or more predicted sequences are aggregated into a single predicted sequence. This may utilize the weights, if computed, from operation 510. At operation 516, a loss function is computed on the single predicted sequence. At operation 518, one or more parameters of the conditional machine learning model are changed based on results of the computing of the loss function.

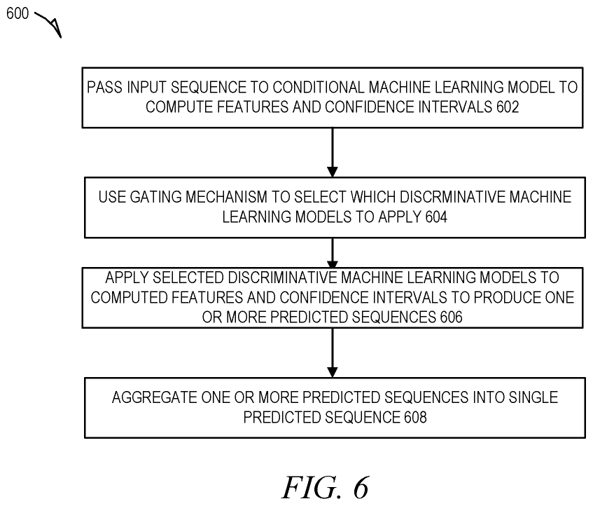

FIG. 6 is a flow diagram illustrating a method 600 of predicting a future sequence based on an input sequence to a sequence-prediction machine learning model, in accordance with an example embodiment.

At operation 602, the input sequence of user interactions is passed into the trained conditional machine learning model to compute features from the input sequence and derive confidence intervals for the computed features of the input sequence. At operation 604, a gating component is used to select which of a plurality of discriminative machine learning models to apply. This may be performed by a hard gating component that selects a single discriminative machine learning model to apply to the computed features and confidence intervals, or by a soft gating component that selects a plurality of discriminative machine learning models to apply to the computing features and confidence intervals and applies weights to each of the plurality of discriminative machine learning models.

At operation 606, the selected one or more discriminative machine learning models are applied to the computed features and confidence intervals to produce one or more predicted sequences. At operation 608, the one or more predicted sequences are aggregated into a single predicted sequence. It should be noted that if there is only a single predicted sequence produced in operation 606, then the “aggregation” may simply involve passing the single predicted sequence from operation 606 as the single predicted sequence from operation 608. When two or more predicted sequences are produced in operation 606, then each predicted sequence may be weighted using the weight corresponding to the discriminative model that generated it. These weights were computed in operation 604. The application of these weights may vary based on the form of the predictions and the implementation of the sequencing forecasting component. For example, if part of the predictions involve numerical predictions (e.g., how many users are expected to engage with the content over the next 24 hours), then the sequence forecasting component may calculate a weighted sum of these predictions, using the weights. Thus, for example, if first discriminative model predicted that 10 users would engage with the content in the next 24 hours and a second discriminative model predicted that 16 users would engage with the content in the next 24 hours, but the weight for the first discriminative model is 0.75 while the weight for the second discriminative model is 0.25, then the aggregated single prediction may be such that it is predicting that (10*0.75)+(16*0.25)=11.5 users are predicted to engage with the content in the next 24 hours.

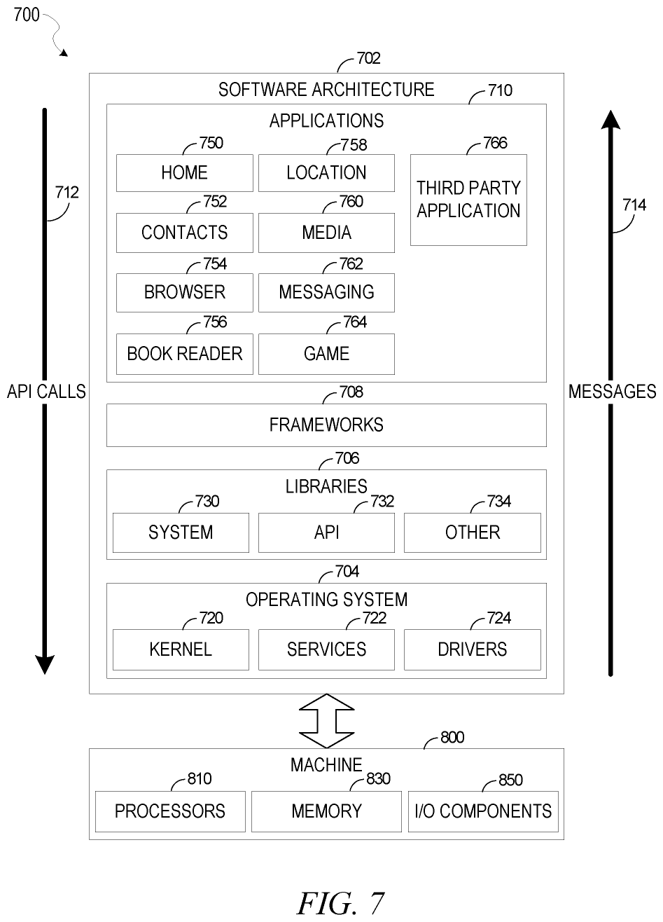

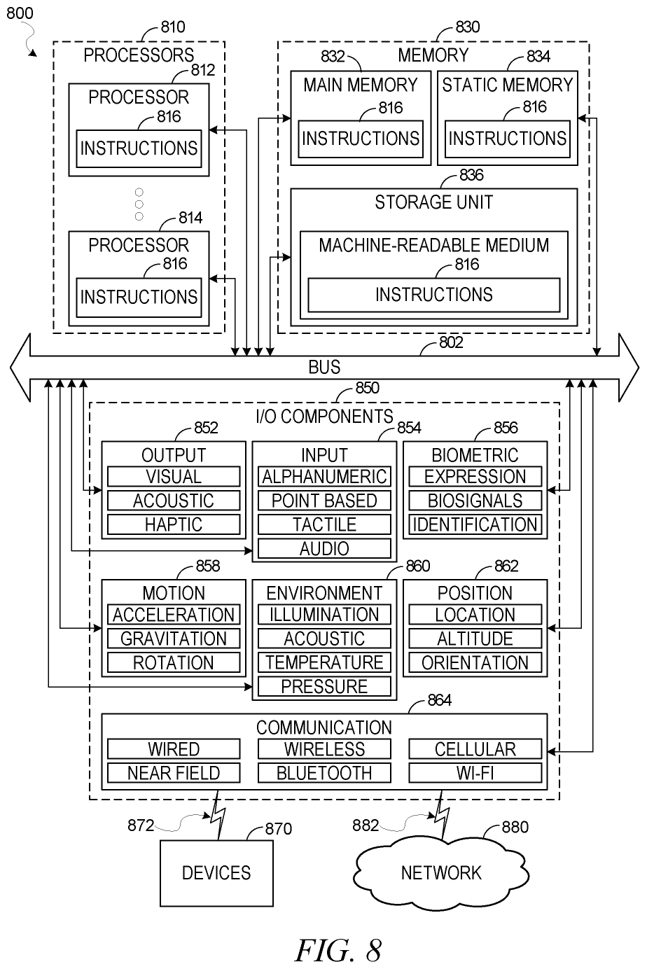

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphical user interface functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application 710, an applet, an app, or other executable code) for causing the machine 800 to perform any one or more of the methodologies discussed herein may be executed. For example, the instructions 816 may cause the machine 800 to execute the methods 500 and 600 of FIGS. 5 and 6, respectively. Additionally, or alternatively, the instructions 816 may implement FIGS. 1-6, and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors 812 (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor), multiple processors 810 with a single core, multiple processors 810 with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine 800 will depend on the type of machine 800. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 830, 832, 834, and/or memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to the processors 810. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 816 may be transmitted or received over the network 880 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a non-transitory computer-readable medium having instructions stored thereon, which, when executed by a processor, cause the system to perform operations for training a sequence-prediction machine learning model comprising:
accessing training data and one or more covariates, the training data comprising sequences of user interactions with an online network, the covariates comprising variables related to the sequences;
modeling a joint distribution using the training data and the covariates to predict regions of interest in the training data;
forming a discriminative joint distribution from the one or more covariates;
passing the discriminative joint distribution to a conditional machine learning model to compute features from the discriminative joint distribution and derive confidence intervals of the training data;
applying one or more discriminative machine learning models to the computed features and confidence intervals to produce one or more predicted sequences;
aggregating the one or more predicted sequences into a single predicted sequence;
computing a loss function on the single predicted sequence; and
changing one or more parameters of the conditional machine learning model based on results of the computing of the loss function.

2. The system of claim 1, wherein the partitioning of the sequences is performed based on how the sequences vary against different classes of the discriminative covariates.

3. The system of claim 1, wherein the operations further comprise:
at inference time:
feeding an input sequence of user interactions into the trained conditional machine learning model to compute features from the input sequence and derive confidence intervals for the computed features of the input sequence; and
applying one or more of the one or more discriminative machine learning models to the computed features from the input sequence and confidence intervals for the computed features of the input sequence to produce one or more inference-time predicted sequences.

4. The system of claim 1, wherein the operations further comprise:
using a gating component to determine from the computed features which of a plurality of the discriminative machine learning models to apply to the computed features and confidence intervals.

5. The system of claim 4, wherein the gating component is a hard gating component that selects a single discriminative machine learning model to apply to the computed features and confidence intervals.

6. The system of claim 4, wherein the gating component is a soft gating component that selects a plurality of discriminative machine learning models to apply to the computing features and confidence intervals, and applies weights to each of the plurality of discriminative machine learning models, the weights utilized during the aggregating.

7. The system of claim 1, wherein the sequences of user interactions include interactions by users of the online network with pieces of content in the online network, the sequences identifying, for each interaction, a particular piece of content interacted with, a user who performed the interaction, and a time of the interaction.

8. The system of claim 1, wherein the forming the discriminative joint distribution includes performing marginal probability modeling to segregate the covariates into discriminative covariates and non-discriminative covariates, and to partition the sequences, to form the discriminative joint distribution;

9. The system of claim 1, wherein the passing the discriminative joint distribution to a conditional machine learning model to compute features from the discriminative joint distribution and derive confidence intervals of the training data is performed by computing deviations in the training data from the discriminative joint distribution;

10. A method comprising:
accessing training data and one or more covariates, the training data comprising sequences of user interactions with an online network, the covariates comprising variables related to the sequences;
modeling a joint distribution using the training data and the covariates to predict regions of interest in the training data;
performing marginal probability modeling to segregate the covariates into discriminative covariates and non-discriminative covariates, and to partition the sequences, to form a discriminative joint distribution;
passing the discriminative joint distribution to a conditional machine learning model to compute features from the discriminative joint distribution and derive confidence intervals of the training data by computing deviations in the training data from the discriminative joint distribution;
applying one or more discriminative machine learning models to the computed features and confidence intervals to produce one or more predicted sequences;
aggregating the one or more predicted sequences into a single predicted sequence;
computing a loss function on the single predicted sequence; and
changing one or more parameters of the conditional machine learning model based on results of the computing of the loss function.

11. The method of claim 10, wherein the partitioning of the sequences is performed based on how the sequences vary against different classes of the discriminative covariates.

12. The method of claim 10, further comprising:
at inference time:
feeding an input sequence of user interactions into the trained conditional machine learning model to compute features from the input sequence and derive confidence intervals for the computed features of the input sequence; and
applying one or more of the one or more discriminative machine learning models to the computed features from the input sequence and confidence intervals for the computed features of the input sequence to produce one or more inference-time predicted sequences.

13. The method of claim 10, further comprising:
using a gating component to determine from the computed features which of a plurality of the discriminative machine learning models to apply to the computed features and confidence intervals.

14. The method of claim 13, wherein the gating component is a hard gating component that selects a single discriminative machine learning model to apply to the computed features and confidence intervals.

15. The method of claim 13, wherein the gating component is a soft gating component that selects a plurality of discriminative machine learning models to apply to the computing features and confidence intervals, and applies weights to each of the plurality of discriminative machine learning models, the weights utilized during the aggregating.

16. The method of claim 10, wherein the sequences of user interactions include interactions by users of the online network with pieces of content in the online network, the sequences identifying, for each interaction, a particular piece of content interacted with, a user who performed the interaction, and a time of the interaction.

17. A system comprising:
means for accessing training data and one or more covariates, the training data comprising sequences of user interactions with an online network, the covariates comprising variables related to the sequences;
means for modeling a joint distribution using the training data and the covariates to predict regions of interest in the training data;
means for performing marginal probability modeling to segregate the covariates into discriminative covariates and non-discriminative covariates, and to partition the sequences, to form a discriminative joint distribution;
means for passing the discriminative joint distribution to a conditional machine learning model to compute features from the discriminative joint distribution and derive confidence intervals of the training data by computing deviations in the training data from the discriminative joint distribution;
means for applying one or more discriminative machine learning models to the computed features and confidence intervals to produce one or more predicted sequences;
means for aggregating the one or more predicted sequences into a single predicted sequence;
means for computing a loss function on the single predicted sequence; and
means for changing one or more parameters of the conditional machine learning model based on results of the computing of the loss function.

18. The system of claim 17, wherein the partitioning of the sequences is performed based on how the sequences vary against different classes of the discriminative covariates.

19. The system of claim 17, further comprising:
means for, at inference time:
feeding an input sequence of user interactions into the trained conditional machine learning model to compute features from the input sequence and derive confidence intervals for the computed features of the input sequence; and
applying one or more of the one or more discriminative machine learning models to the computed features from the input sequence and confidence intervals for the computed features of the input sequence to produce one or more inference-time predicted sequences.

20. The system of claim 17, further comprising:
means for using a gating component to determine from the computed features which of a plurality of the discriminative machine learning models to apply to the computed features and confidence intervals.
